(19) United States
(12) Patent Application Publication
(10) Pub. No.: US 2006/0018223 A1
(43) Pub. Date: Jan. 26, 2006

(54) Image forming apparatus and method to print a plurality of files stored in portable recording medium

(76) Inventors: Jong-heon Ji, Suwon-si (KR); Tae-sun Yoon, Anyang-si (KR)

Correspondence Address: STANZIONE & KIM, LLP, 919 18TH STREET, N.W., SUITE 440, WASHINGTON, DC, 20006, US

(21) Appl. No.: 11/179,609

(22) Filed: Jul. 13, 2005

(30) Foreign Application Priority Data
Jul. 26, 2004 (KR) 2004-58294
Dec. 4, 2004 (KR) 2004-101484

(51) Int. Cl. G11B 20/10

(52) U.S. Cl. 369/47.12; 369/47.1

(57) ABSTRACT

An image forming apparatus and a method to print a plurality of files stored in a portable recording medium. The image forming apparatus to receive the files stored in the portable recording medium includes an interface unit to provide a communication interface with the portable recording medium, and a control unit connectable with the portable recording medium through the interface unit to control the interface unit to receive the files stored in one selected directory among directories of the portable recording medium through the interface unit. The selection of one of the directories takes place even without individually selecting to-be-printed files among the files stored in the portable recording medium. As a result, among the files stored in the selected directory, a plurality of printable files are simultaneously printed out, thereby providing convenience to users.

### CROSS-REFERENCE TO RELATED APPLICATIONS

This application claims under 35 U.S.C, §119 the benefit of Korean Patent Application Nos. 2004-58294 filed on Jul. 26, 2004; and 2004-101484 filed on Dec. 4, 2004, in the Korean Intellectual Property Office, the disclosures of which are incorporated herein by reference.

### BACKGROUND OF THE INVENTION

1. Field of the Invention

The present general inventive concept relates to an image forming apparatus and a method to print a plurality of files, and more particularly, to an image forming apparatus and a method to extract printable files among a plurality of files existing within a selected directory stored in a portable recording medium connectable with an image forming apparatus and to print the extracted files.

2. Description of the Related Art

An image forming apparatus prints files generated within the image forming apparatus or stored in a recording medium onto one or more sheets of printing paper. A developer, such as, a toner is used to print the files onto the printing paper. Typical examples of the image forming apparatus are printers, photocopiers, scanners, facsimiles, and multi-function peripheral (MFP) machines into which multi-functions are implemented complexly.

The recording medium stores to-be-printed files and includes a hard disc drive (HDD) installed inside of the image forming apparatus and a portable recording medium connectable with the image forming apparatus.

The portable recording medium is attachable to and detachable from the image forming apparatus. The portable recording medium includes HDDs, random access memory (RAM) cards, flash memory cards, memory sticks, and the like.

Recently, digital cameras, mobile terminals installed with digital cameras, moving picture experts group 3 (MP3) players, and the like have been commercialized to be used as the portable recording medium capable of storing files and attachable to and detachable from the image forming apparatus.

A universal serial bus (USB) mode is one of interface modes for connecting the portable recording medium with the image forming apparatus. As the image forming apparatus is connected with the portable recording medium through the USB mode, it is possible to print out the files stored in the portable recording medium on the printing paper.

In a conventional image forming apparatus connectable with the portable recording medium through the USB mode, a user is compelled to search for files stored in the portable recording medium and select the files individually to print the stored files of the portable recording medium.

In more detail, as the image forming apparatus is connected with the portable recording medium, information on the files stored in the portable recording medium is read and displayed. Then, the user selects one of the files to be printed when the files are displayed. After the selection of the one file, as the user authenticates a print instruction to the image forming apparatus, the image forming apparatus prints the selected file. If the number of the files to be printed is more than one, it is necessary to repeat the above described steps in order to print a number of files.

Therefore, it is complicated for the user to search for the information on files stored in the portable recording medium one by one and individually select each of the files to be printed. Also, the user has to authenticate the print instruction repeatedly to print the selected files. As a result of this individual selection of the files to be printed, it may take longer to print the plurality of files intended to be printed.

### SUMMARY OF THE INVENTION

The present general inventive concept provides an image forming apparatus capable of printing a plurality of printable files simultaneously among files stored in one directory selected among directories stored in a portable recording medium and a method of printing the plurality of the selected printable files.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an image forming apparatus to receive files stored in a connectable portable recording medium, the image forming apparatus comprising an interface unit to provide a communication interface with the portable recording medium, and a control unit connectable with the portable recording medium through the interface unit to control the interface unit to receive the files stored in one selected directory among directories of the portable recording medium through the interface unit.

The image forming apparatus may further comprise a display unit to display directories having the files stored in the portable recording medium to select at least one directory among the directories.

The image forming apparatus may further comprise a key input unit to authenticate a request signal to select the at least one directory among the directories having the files stored in the portable recording medium.

The control unit may extract printable files among the files stored in the selected directory on the basis of information on the files stored in the selected directory.

The image forming apparatus may further comprise a print unit to print the files according to a user selection among the extracted files as being controlled by the control unit.

The information on the files may be one of file extensions and contents of headers of the files.

If the directory of the portable recording medium is not selected, files to be printed are selected among the files stored in the portable recording medium.

the foregoing and/or other aspects of the present general inventive concept may also be achieved by providing a method of printing a plurality of files in an image forming apparatus to receive the files stored in a connectable portable recording medium, the method comprising providing a communication interface with the portable recording medium, and receiving the files stored in a selected directory among directories in which the files are stored in the portable recording medium, through the communication interface.

The method may further comprise displaying directories in which files of the portable recording medium are stored in order to select at least one directory among the directories.

The method may further comprise authenticating a request signal to select at least one directory among directories in which the files are stored in the portable recording medium.

The method may further comprise extracting printable files among the files stored in the selected directory on the basis of information on the files of the selected directory.

The method may further comprise printing files among the extracted files according to a user selection.

The information on the files of the selected directory may be one of file extensions and contents of headers of the files.

The method may further comprise selecting files to be printed among the files stored in the portable recording medium if the selected directory is determined not to be printed.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram showing a printing system having an image forming apparatus according to an embodiment of the present general inventive concept; and

FIG. 2 is a flowchart showing a method of printing out a plurality of files of an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

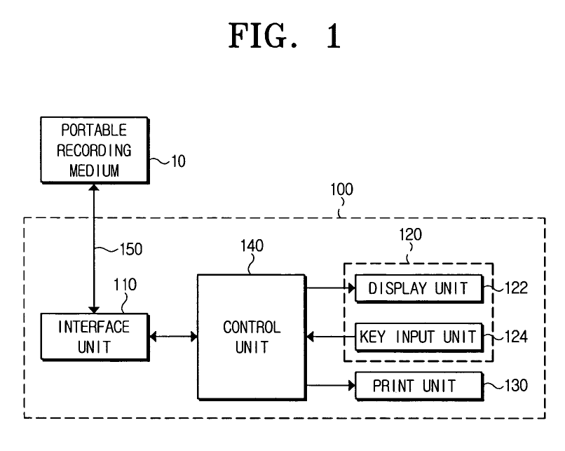

FIG. 1 is a block diagram showing a printing system having an image forming apparatus according to an embodiment of the present general inventive concept.

As shown in FIG. 1, the printing system includes a portable recording medium 10 and an image forming apparatus 100.

Image files including pictures and photographs and text files including documents are stored in the portable recording medium 10. More specifically, the image and text files are stored in corresponding directories constituted according to contexts related files or to-be-printed files.

Table 1 provided below represents exemplary files stored in each constituted directory of the portable recording medium 10.

TABLE 1

| Directory 1 | Directory 2 | Directory 3 |
|---|---|---|
| picture1.gif | document2.HML | text2.HLT |
| document1.hwp | photograph2.jpg | picture3.gif |
| photograph1.jpg | document2-1.TXT | — |
| Text1.bkg | photograph2-1.jpg | — |

As shown in Table 1, in the directory 1, various types of to-be-printed files, such as the picture1, the document1, the photograph1 and the text1 are stored. The context related files, such as the document2, the photograph2, the document 2-1, and the photograph2-1, are stored in the directory 2. In the directory 3, files as the text2 and the picture3 are stored. A user of the portable recording medium 10 can set and change names of the directories and files.

As the portable recording medium 10 is connected with the image forming apparatus 100, the image forming apparatus 100 prints out the files stored in one directory selected by a user among the directories of the portable recording medium 10, on one or more sheets of printing paper. Also, the image forming apparatus 100 prints out each of the files selected by the user among the files stored in the portable recording medium 10 on the sheets of the printing paper.

The portable recording medium 10 and the image forming apparatus 100 are connected with each other through a universal serial bus (USB) cable 150. As the portable recording medium 10 is connected with the image forming apparatus 100 through the USB cable 150, the portable recording medium 10 transfers the files stored in the selected directory to the image forming apparatus 100 through the USB cable 150 in a USB interface mode.

The image forming apparatus 100 includes an interface unit 110, an operation panel block 120, a print unit 130, and a control unit 140.

The interface unit 110 is configured to interface the image forming apparatus 100 with the portable recording medium 10. Particularly, the interface unit 110 transfers files and allows the portable recording medium 10 and the image forming apparatus 100 to communicate with each other for exchanging information.

In more detail, when the portable recording medium 10 is connected with the image forming apparatus 100 by employing the interface unit 110, the interface unit 110 transfers information on the directories of the portable recording medium 10 and information on the files stored in the directories to the control unit 140. Also, the interface unit 110 transfers the files of the selected directory to the control unit 140, so that the print unit 130 can print the transferred files stored in the selected directory of the portable recording medium 10.

The operation panel block 120 serves a role in displaying an operation status of the image forming apparatus 100 or in receiving an instruction input by a user. The operation panel block 120 includes a display unit 122 and a key input unit 124.

The display unit 122 displays an operation status of the image forming apparatus 100 and is formed by using a liquid crystal display (LCD) or a light emitting diode (LED) display.

When the portable recording medium 10 is connected with the image forming apparatus 100, the display unit 122 displays a connection status of the portable recording medium 10. Also, the display unit 122 displays the information on the directories of the portable recording medium 10 and the information on the files stored in the respective directories both being transferred through the interface unit 110.

As a user selects one of the directories, the display unit 122 displays a message to ask the user about a directory print, i.e., the message to determine whether to print all of the files stored in the selected directory. Also, the display unit 122 displays a list of printable files among the files stored in the selected directory and a print status of the files while being printed.

The user selects a directory to be printed among the directories stored in the portable recording medium 10 using the key input unit 124. Also, as a selection window showing the above message about the directory print of the files appears on the display unit 122, the user selects whether to print the directory print using the key input unit 124.

Also, if it is determined not to print the files stored in the selected directory, the user uses the key input unit 124 to select files to be printed among the files stored in the portable recording medium 10.

The print unit 130 prints out a plurality of printable files among the files stored in the selected directory of the portable recording medium 10 on the sheets of the printing paper.

The control unit 140 controls configuration elements of the image forming apparatus 100 and makes the files stored in the selected directory of the portable recording medium 10 printed.

More particularly, when the portable recording medium 10 is connected with the interface unit 110 through the USB interface mode, the control unit 140 detects the connection of the portable recording medium 10.

As the connection of the portable recording medium 10 is detected, the control unit 140 controls the interface unit 110 to read the information on directories of the portable recording medium 10 and the information on the files stored in the directories.

Also, as the user selects a directory of the portable recording medium 10, the control unit 140 makes a window to select the directory print displayed by the display unit 122.

If the directory print is selected, the control unit 140 controls the interface unit 110 to receive the files stored in the selected directory. Also, on the basis of the information on the files of the selected directory, the control unit 140 extracts the files that can be printed out among all files stored in the selected directory. The information on the files of the selected directory includes file extensions, contents of headers of the files and the like. The file extension is a set of letters placed after the punctuation of period in a file name to classify the type of file. Examples of the file extensions for the printable files are ‘*.jpg,’ ‘*.hwp,’ ‘*.HLT,’ ‘*.HML,’ ‘*.TXT’ and so forth. Here, the symbol ‘*’ represents a file name. The header is a group of letters placed before a data file and contains information on contents of the file, characteristics and so on.

The control unit 140 controls the print unit 130 and makes the extracted printable files printed on the sheets of the printing paper.

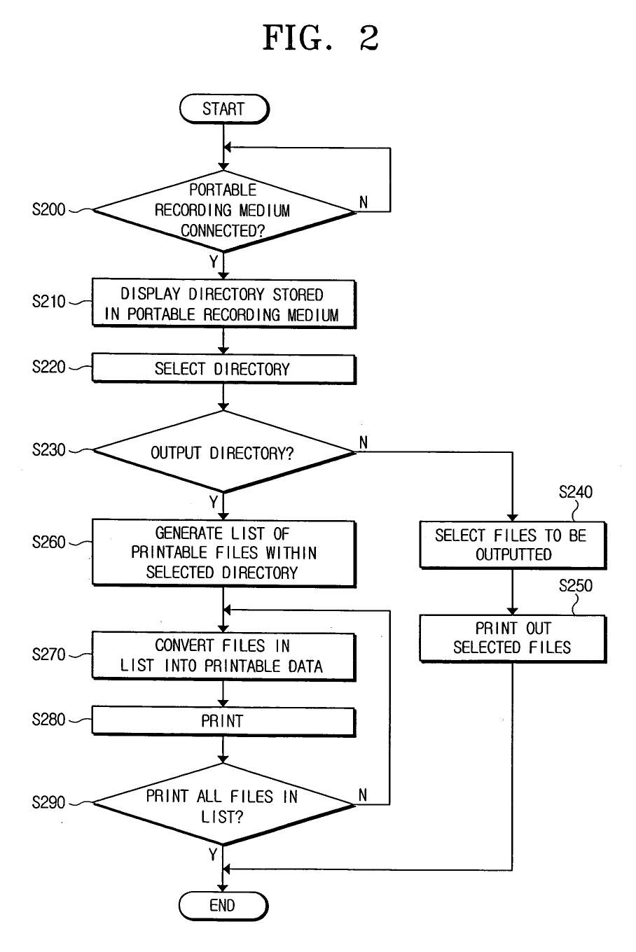

FIG. 2. is a flowchart showing a method of printing out a plurality of files in a printing system having an image forming apparatus according to an embodiment of the present general inventive concept.

Referring to FIGS. 1 and 2, at operation S200, the control unit 140 detects whether the portable recording medium 10 is connected with the interface unit 110 of the image forming apparatus 100. Depending on the communication between the interface unit 110 and the portable recording medium 10 through the USB mode, the control unit 140 detects whether the portable recording medium 10 is connected with the image forming apparatus 100. That is, the control unit 140 detects the connection between the portable recording medium 10 and the image forming apparatus 100 when the portable recording medium 10 communicates with the interface unit 110 through the USB mode.

Next, at operation S210, as the connection of the portable recording medium 10 is detected, the control unit 140 makes directories stored in the portable recording medium 10 displayed. The control unit 140 controls the interface unit 110 to read the information on the directories of the portable recording medium 10 and the information on the files stored in the directories of the portable recording medium 10.

After the displayed directories are searched, at operation S220, a user selects a directory in which the files desired to be printed are stored, using the key input unit 124.

As the directory is selected, the control unit 140 determines whether or not the selected directory is printed at operation S230. Also, the control unit 140 makes a window showing a message asking about a print of the selected directory displayed. If the print of the selected directory is decided, i.e., if it is intended to print a plurality of the files stored in the selected directory, the user selects the print of the selected directory by using the key input unit 124. If it is not necessary to print all of the files stored in the selected directory, the user does not select the print of the selected directory.

At operation S240, if the print of the directory is not selected, the user selects a file to be printed among the files stored in the selected directory using the key input unit 124.

If the to-be-printed file is selected, at operation S250, the control unit 140 controls the print unit 130 to print the selected file onto the sheet of the printing paper.

If the print of the directory is selected at operation S230, the control unit 140 extracts printable files among the files stored in the selected directory and generates a list of the printable files at operation S260. At this time, the control unit 140 extracts the printable files based on the information on the files of the selected directory including file extensions, contents of headers of the files and so on.

At operation S270, the control unit 140 converts the files in the list into a form of printable data. The control unit 140 converts the files, stored in a form of a bit map at the portable recording medium 10 and transferred through the interface unit 110, into analog data for printing.

At operation S280, the control unit 140 controls the print unit 130 to print the files converted into the analog data onto the sheet of the printing paper. The control unit 140 prints the files sequentially as in the list.

The control unit 140 determines whether the files in the list are printed onto the sheets of the printing paper at operation S290. If it is determined that all of the files in the list are not completely printed, the control unit 140 repeats the operations S270 to S280.

In the above embodiment of the present general inventive concept, the use of the USB interface mode is exemplified as an interface for connecting the portable recording medium with the image forming apparatus. However, the present invention is still applicable to such connection modes as a plug and play (PnP) mode and an IEEE1394 interface mode.

The above method of FIG. 2 may be implemented in a computer readable recording medium, such as any type of semiconductor memory devices, magnetic or optical recording discs, or a data storage medium. The computer readable recording medium used with the image forming apparatus may include codes to perform the printing method of providing a plurality of directories each having a plurality of files, selecting one of the plurality of the directories, and printing printable files of the plurality of files contained in the selected one of the plurality of directories according to the selection of the one of the plurality of directories.

As described above, a desired directory is selected without individually selecting to-be-printed files among files stored in the portable recording medium, and thus, among files stored in the selected directory, a plurality of printable files are printed at once. This simultaneous printing of the selected files provides convenience to users. Also, it is possible to reduce a time taken for printing out the selected files.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus to receive files stored in a connectable portable recording medium, comprising:
an interface unit to provide a communication interface with the portable recording medium; and
a control unit connectable with the portable recording medium through the interface unit to select one of directories of the portable recording medium and receive files stored in the one selected directory among the directories of the portable recording medium through the interface unit.

2. The image forming apparatus of claim 1, further comprising:
a display unit to display the directories having the files stored in the portable recording medium to select at least one directory among the directories.

3. The image forming apparatus of claim 1, further comprising:
a key input unit to authenticate a request signal to select the one directory among the directories having the files stored in the portable recording medium are recorded.

4. The image forming apparatus of claim 1, wherein the control unit extracts printable files among the files stored in the selected directory according to information on the files stored in the selected directory.

5. The image forming apparatus of claim 1, further comprising:
a print unit to print at least one of the extracted files according to a user selection under the control of the control unit.

6. The image forming apparatus of claim 4, wherein the information on the files comprises one of file extensions and contents of headers of the files.

7. The image forming apparatus of claim 1, wherein if the directory of the portable recording medium is not selected, files to be printed are selected among the files stored in the portable recording medium.

8. A method of printing a plurality of files in an image forming apparatus to receive files stored in a connectable portable recording medium, the method comprising:
providing a communication interface with the portable recording medium; and
receiving files stored in a selected directory among directories having the files stored in the portable recording medium, through the communication interface.

9. The method of claim 8, further comprising:
displaying the directories in which the files of the portable recording medium are stored in order to select at least one directory among the directories as the selected directory.

10. The method of claim 8, further comprising:
authenticating a request signal to select at least one directory among directories in which the files of the portable recording medium are stored, as the selected directory.

11. The method of claim 8, further comprising:
extracting printable files among the files stored in the selected directory on the basis of information on the files of the selected directory.

12. The method of claim 8, further comprising:
printing at least one of the extracted files according to a user selection.

13. The method of claim 11, wherein the information on the files of the selected directory comprises one of file extensions and contents of headers of the files.

14. The method of claim 8, further comprising:
selecting files to be printed among the files stored in the portable recording medium if the selected directory is determined not to be printed.

15. An image forming apparatus to receive files stored in a connectable portable recording medium, comprising:
an interface unit to provide a communication interface with a portable recording medium having a plurality of directories each having a plurality of files; and
a control unit connectable with the portable recording medium through the interface unit to select one of the directories of the portable recording medium, and
a print unit to simultaneously print printable files of the plurality of the files stored in the selected directory according to the selection of the one of the directories.

16. The image forming apparatus of claim 15, further comprising:
a display unit to display the plurality of files contained in the selected one of the directories according to the selection of the one of the directories.

17. The image forming apparatus of claim 15, further comprising:
a display unit to display the printable files contained in the selected directory according to the selection of the one of the directories.

18. The image forming apparatus of claim 15, wherein the print unit prints the printable files contained in the selected directory without selection each of the printable files.

19. The image forming apparatus of claim 15, wherein the control unit selects a directory print mode corresponding to the selected directory to print the printable files contained in the selected directory.

20. The image forming apparatus of claim 15, wherein the control unit selects a directory print mode, and the print unit prints the printable files contained in the selected directory according to the directory print mode.

21. The image forming apparatus of claim 15, wherein the plurality of files comprise the printable files and non-printable files in the selected directory of the portable recording medium, and the print unit automatically print the printable files without selecting each of the printable files according to the selection of the one of the directories.

22. The image forming apparatus of claim 15, wherein the interface unit receives a list of the plurality of directories from the portable recordable medium, the control unit selects the one of the plurality of directories from the received list and generates the printable files contained in the selected directory through the interface unit, and the print unit prints the generated printable files.

23. The image forming apparatus of claim 15, wherein the print unit prints the printable files of the plurality of the files stored in the selected directory according to the selection of the one of the directories without selecting the respective files.

24. A computer readable portable recording medium connectable with an image forming apparatus to perform a printing method comprising:
providing a plurality of directories each having a plurality of files;
selecting one of the plurality of the directories; and
printing printable files of the plurality of files contained in the selected one of the plurality of directories according to the selection of the one of the plurality of directories.
